(19) United States
(12) Patent Application Publication
(10) Pub. No.: US 2008/0150923 A1
(43) Pub. Date: Jun. 26, 2008

(54) METHOD AND DISPLAY SYSTEM FOR SYNCHRONIZING DATA STORED IN A MONITOR AND A VIDEO SIGNAL SOURCE

(76) Inventor: Min-Jye Chen, Miao-Li City (TW)

Correspondence Address: NORTH AMERICA INTELLECTUAL PROPERTY CORPORATION, P.O. BOX 506, MERRIFIELD, VA, 22116, US

(21) Appl. No.: 11/962,102

(22) Filed: Dec. 21, 2007

(30) Foreign Application Priority Data
Dec. 26, 2006 (TW) 095148991

(51) Int. Cl. G06F 3/038

(52) U.S. Cl. 345/204

(57) ABSTRACT

A display system synchronizes data stored in a video signal source and a monitor by detecting the state of a status pin coupled between the video signal source and the monitor. When DDC/CI function is on and a user adjusts the display parameter in the monitor by directly operating the buttons installed on the monitor, the monitor alters state of the status pin to an “inconsistent” state. Once the video signal source detects the “inconsistent” state of the status pin, the video signal source then updates the display parameter of the video signal source according to the display parameter of the monitor.

### BACKGROUND OF THE INVENTION

1. Field of the Invention

The present invention relates to a data transmitting method and a display system, and more specifically, to a method and display system for synchronizing data stored in a monitor and a video signal source.

2. Description of the Prior Art

In the development of display technology, monitors that support display data channel/command interface (DDC/CI) function have been more and more common in the marketplace. Unlike a traditional monitor, whose display parameter needs to be adjusted through pressing the buttons on the monitor panel, DDC/CI function in the monitor allows a user to adjust the display parameter and apply the adjustment to the monitor directly through a DDC/CI software in the computer end, along with a concurrent presentation of the adjustment process and adjustment outcome on the monitor.

For a monitor and a computer end that support DDC/CI function, the display parameter is stored in both ends respectively. When a user adjusts the display parameter in the computer end through the DDC/CI software, the DDC/CI software transmits a DDC/CI signal to the monitor to update the display parameter in the monitor. The monitor the displays the video signals according to the updated display parameter: a MCU in the monitor reads the display parameter stored in an EEPROM of the monitor and controls the monitor to display the video signals according to the display parameter. The DDC/CI software stores the updated display parameter in the computer end as well. Each time the user adjusts the display parameter of the monitor through the DDC/CI software in the computer end, the DDC/CI software provides the display parameter stored in the computer end as an initial and base setting (the same as the display parameter in the monitor) for the user.

On the other hand, in a monitor that supports DDC/CI function, a user can still adjust the display parameter of the monitor directly through a user interface on the monitor and stores the result in the EEPROM of the monitor. However, since the DDC/CI function is designed for one-way transmitting the DDC/CI signals from the computer end to the monitor, the monitor cannot initiate a data transmission to the computer end via the DDC/CI channel and therefore, an inconsistence of the display parameter between the monitor and the computer end is likely to occur when the user adjusts the display parameter in the monitor. This inconsistence causes some problems. For example, if the user finishes a first adjustment of display parameter in the computer end by operating the DDC/CI software, the monitor displays the video signals according to the a display parameter A, which is stored in both the monitor and the computer end. When the user again adjusts the display parameter on the basis of display parameter A but the display parameter A in the monitor through operating the buttons on the monitor, the display parameter in the monitor is adjusted to display parameter B while the display parameter in the computer end remains the display parameter A (this is because the adjustment of the display parameter in the monitor does not initiate the update of the display parameter in the computer end with the DDC/CI function). When the user makes an adjustment again with the display parameter through the DDC/CI software in the computer end, the DDC/CI software makes the adjustment on the basis of the display parameter A (in the computer end) rather than the display parameter B which bring about some inconvenience to the adjustment of the display parameter.

### SUMMARY OF THE INVENTION

The present invention provides a method for transmitting data between a monitor and a video signal source. The monitor comprises a monitor user interface and a monitor control unit, and the video signal source comprises a control unit. A video interface, a data interface, and a status pin couple between the monitor and the video signal source. The monitor stores a first display parameter and the video signal source stores a second display parameter. The video signal source is capable of transmitting a video signal to the monitor via the video interface, the monitor is capable of displaying the video signal according to the first display parameter, and the status pin is capable of being selectively set to a “consistent” state or an “inconsistent” state. The method comprises the monitor control unit setting the status pin to the “inconsistent” state when a user adjusts the first display parameter through the monitor user interface; the control unit updating the second display parameter according to the first display parameter via the data interface when the control unit detects the “inconsistent” state of the status pin; and setting the status pin to the “consistent” state when the update of the second display parameter is completed.

The present invention also provides a display system. The display system comprises a monitor storing a first display parameter and a video signal source storing a second display parameter. The monitor is utilized for displaying a video signal according to the first display parameter and comprises a monitor user interface for adjusting the first display parameter, and a monitor control unit for setting a status pin out of a “consistent” state when a user adjusts the first display parameter through the monitor user interface. The status pin is capable of being selective set to or out of the “consistent” state. Between the monitor and the video signal source couple a video interface, the status pin, and a data interface. The video signal source is utilized for transmitting the video signal to the monitor via the video interface and comprises a control unit for updating the second display parameter according to the first display parameter via the data interface when detecting the status pin being set out of the “consistent” state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a method for synchronizing data stored in a monitor and a video signal source respectively according to the present invention.

FIG. 2 is an illustration of the display system according to the method of the present invention.

FIG. 3 is an illustration of a D-sub connector.

### DETAILED DESCRIPTION

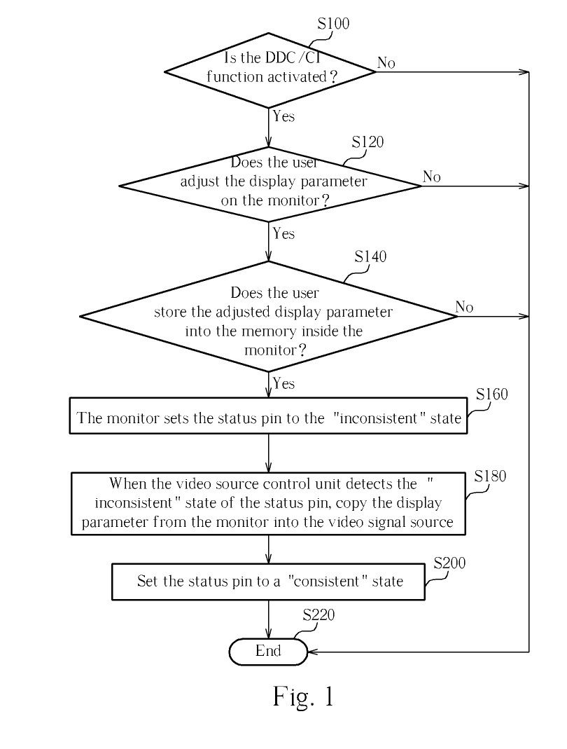

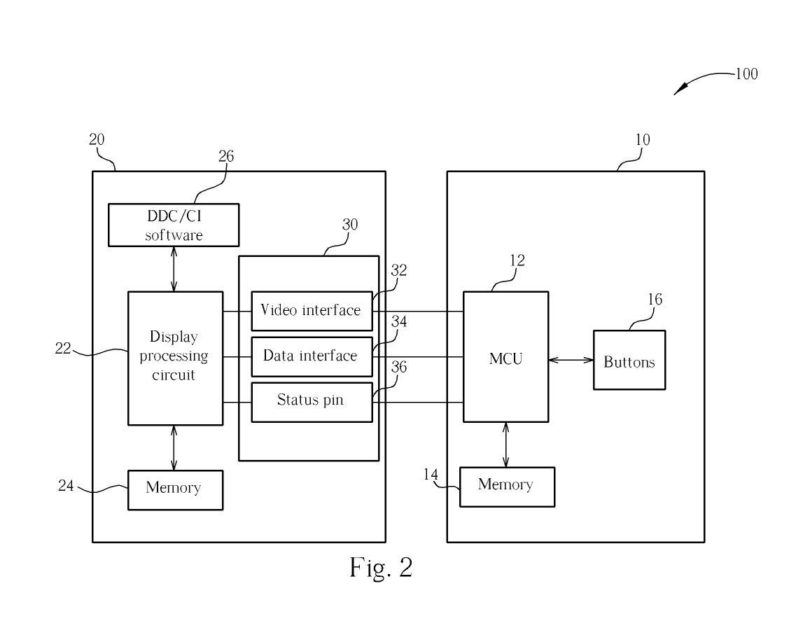

The present invention synchronizes the values of display parameters respectively stored in a monitor and a video signal source. In a preferred exemplary embodiment according to the present invention, the values of the display parameters stored in the video signal source and the monitor are synchronized by way of establishing a handshake pin between the video signal source and the monitor. Please refer to FIG. 1 and FIG. 2. FIG. 1 is a flow chart of the method for synchronizing data stored in a monitor and a video signal source respectively. FIG. 2 is an illustration of a display system 100 that applies the method of the present invention. The display system 100 comprises a monitor 10 and a video signal source 20. The video signal source 20 can be a personal computer or other sorts of devices capable of providing video signals, for example, a DVD player or a Set-top Box. Instead of being implemented inside the video signal source 20 as the exemplary embodiment in FIG. 2, the transmission interface 30 can also be implemented inside the monitor 10.

The steps of the method are as followed:

Step S100: Check whether the DDC/CI function in the display system is activated; if the DDC/CI function is not activated, execute Step S220;

Step S120: The monitor 10 detects whether the user is adjusting the display parameter by operating the buttons 16 installed on the monitor 10; if not, execute Step S220;

Step S140: The monitor 10 detects whether the user operates the buttons 16 installed on the monitor 10 to control the MCU 12 to store the adjusted display parameter into the memory 14 inside the monitor 10, which means the inconsistence between the display parameter stored in the video signal source 20 and the display parameter stored in the monitor 10 may occur;

Step S160: The monitor 10 sets the status pin 36 to the “inconsistent” state;

Step S180: When the video source control unit 22 of the video signal source 20 detects the “inconsistent” state of the status pin 36, the control unit 22 copies the display parameter from the monitor 10 and stores the display parameter into the memory 24 on the video signal source 20;

Step S200: The video signal source 20 or the monitor 10 sets the status pin 36 to a “consistent” state;

Step S220: End.

In the display system 100, the video signal source 20 comprises a control unit 22, a memory 24, and a DDC/CI software 26. The transmission interface 30 in the video signal source 20 comprises a video interface 32, a data interface 34, and a status pin 36. The memory 24 is a non-volatile memory (for example, an EEPROM) that is capable of keeping the second display parameter when the video signal source 20 is turned off. The video interface 32 is utilized for transmitting the video signals generated by the video signal source 20. The data interface 34 is utilized for transmitting the DDC/CI signals for controlling the monitor 10 from the video signal source 20, and the status pin 36 is utilized for being set into a “consistent” state or an “inconsistent” state by changing the voltage level of the pin.

The monitor 10 comprises a micro control unit (MCU) 12, a memory 14, and buttons 16 (or in other words, a monitor user interface). The memory 14 is a non-volatile memory that is capable of keeping the first display parameter when the monitor 10 is turned off. When the video signal source 20 transmits the video signals to the monitor 10 via the video interface 32, the MCU 12 controls the monitor 10 to display the video signals according to the first display parameter.

When a user directly operates the buttons 16, the first display parameter stored in the monitor 10 is adjusted, and the corresponding adjustment process and adjustment outcome are displayed on the monitor 10.

However, via the DDC/CI interface in the display system 100, the first display parameter stored in the monitor 10 can also be adjusted when a user operating the video signal source 20.

Step 100: When the DDC/CI software 26 in the video signal source 20 is activated, that means the user may adjust the second display parameter stored in the memory 24 by operating the source user interface provided by the video signal source 20, and the control unit 22 then may transmit the adjusted second display parameter to the monitor 10 via the DDC/CI data interface 34. The source user interface provided by the video signal source 20 can be input devices such as the keyboard or the mouse. When receiving the adjusted second display parameter, the MCU 12 updates the first display parameter stored in the memory 14 based on the adjusted second display parameter. The MCU 12 then controls the monitor 10 to display the video signals according to the updated first display parameter.

Note that the DDC/CI data interface 34 is an interface controlled by the video signal source 20 to exchange the DDC/CI signals with the monitor 10.

Step S120-160: After the user finishes adjusting the second display parameter stored in the video signal source 20, if the user (1) further adjusts the first display parameter in the monitor 10 by operating the buttons 16 (Step S120) installed on the monitor 10, and (2) the adjusted first display parameter is then stored in the memory 14 to overwrite the first display parameter updated in step 100 by operating the buttons 16 (Step S140), then the MCU 12 changes the voltage level of the status pin 36 so as to set the status pin 36 to the “inconsistent” state (Step S160).

Step S180: Once the control unit 22 of the video signal source 20 detects the “inconsistent” state of the status pin 36, the video signal source 20 initiates the update procedure for the second display parameter. The control unit 22 sends a signal to the monitor 10 via the DDC/CI data interface 34 and requests the monitor 10 to transmit the first display parameter stored in the memory 14 of the monitor 10 to update the value of the second display parameter stored in the memory 24 of the video signal source 20. After the update, both the first and second display parameters stored in the monitor 10 and the video signal source 20 have the consistent value same as the result that the user previously adjusted through the buttons 16 and therefore, the synchronization of the values of both display parameters between the monitor 10 and the video signal source 20 is done.

Step S200: When the control unit 22 completes updating the second display parameter, the control unit 22 sets the status pin 36 to the “consistent” state by changing the voltage level of the status pin 36. However, the control unit 22 can also change the voltage level of the status pin 36 by sending a signal to the MCU 12 of the monitor 10 via the DDC/CI data interface 34, and the MCU 12 then changes the voltage level of the status pin 36 to set it to the “consistent” state after receiving the signal from the control unit 22.

The voltage level of the status pin 36 determines whether the video signal source 20 should update the value of the second display parameter by requesting the value of the first display parameter from the monitor 10. The status pin 36 is set to the “inconsistent” state only after the user has pressed the buttons 16 to control the MCU 12 to adjust and store the adjusted first display parameter, and the video signal source 20 only updates the second display parameter when detecting the “inconsistent” state of the status pin 36.

The Windows operating system allows the computer to obtain the model number and serial number of the currently connected monitor via the DDC/CI data interface 34. Two additional exemplary embodiments of the present invention are disclosed in the following paragraphs to illustrate how the values of the first and the second display parameters are initially synchronized once the video signal source 20 is turned on or connecting to a new monitor 10.

(1) If the monitor 10 in the display system 100 is replaced by a new monitor when the video signal source 20 is off, then when the video signal source 20 turns on again, the video signal source 20 will recognize a new monitor is connected, because the model number (or the serial number) of the connected monitor is different. Therefore, the control unit 22 will overwrite the first display parameter of the new monitor with the second display parameter stored in the video signal source 20, allowing the display system 100 for displaying the video signals according to the display parameter previously set by the user.

(2) If the monitor 10 in the display system 100 hasn't been replaced, i.e., the model number (or the serial number) of the monitor 10 remains the same when the video signal source 20 is turned on again, the control unit 22 of the video signal source 20 will overwrite the second display parameter stored in the video signal source 20 with the first display parameter in the monitor 20 via the DDC/CI data interface 34.

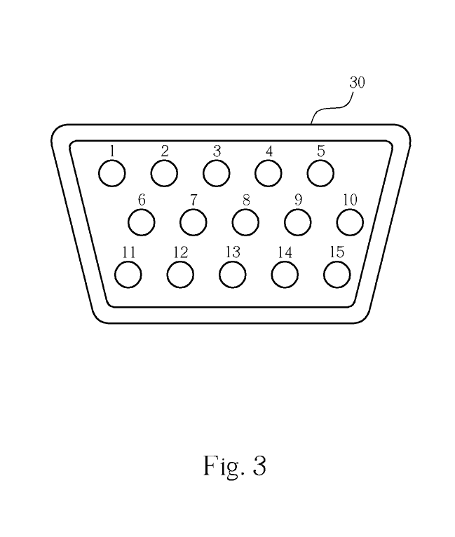

FIG. 3 refers to an exemplary embodiment of the transmission interface 30 in the display system 100 of the present invention. The transmission interface 30 complies with either one of the popular video standards, like: D-sub, DVI, or HDMI interfaces. For example, FIG. 3 shows an illustration of a D-sub connector with 15 pins. In the exemplary embodiment in FIG. 3, the present invention utilizes pins #1,2,3,6,7,8,13,14 as the video interface 32, wherein pins #1,2,3,6,7,8 are for transmitting R,G,B color related video signals and pins #13,14 are for transmitting the V-sync and H-sync signals. The data interface 34 utilizes pins #12,15 to transmit the DDC/CI signals and to receive data from the monitor 10. And pin #4 or pin #11, which is a reserved pin in the D-sub specification, is utilized in the exemplary embodiment as the status pin 36. Taking pin #11 as the status pin 36 for example, if its high voltage level represents the “inconsistent” state and its low voltage level represents the “consistent” state, the MCU 12 sets the pin #11 to its high voltage level once the user adjusts the display parameter of the monitor 10 through the buttons 16. And when the control unit 22 detects the high voltage level of the pin #11, the synchronization of the display parameters aforementioned is triggered.

The display system of the present invention synchronizes data between a video signal source and a monitor by detecting the state of a status pin coupled between the video signal source and the monitor. When DDC/CI function is on and a user adjusts the display parameter in the monitor by operating the buttons of the monitor, the monitor sets the status pin to an “inconsistent” state. Once the video signal source detects the “inconsistent” state of the status pin, the video signal source then updates the display parameter stored in the video signal source according to the display parameter stored in the monitor via DDC/CI signals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for transmitting data between a monitor and a video signal source, the monitor comprising a monitor user interface and a monitor control unit, the video signal source comprising a control unit, and a video interface, a data interface, and a status pin coupling between the monitor and the video signal source, the monitor storing a first display parameter and the video signal source storing a second display parameter, the video signal source capable of transmitting a video signal to the monitor via the video interface, the monitor capable of displaying the video signal according to the first display parameter, the status pin capable of being selectively set to a “consistent” state or an “inconsistent” state, the method comprising:
the monitor control unit setting the status pin to the “inconsistent” state when a user adjusts the first display parameter through the monitor user interface;
the control unit updating the second display parameter according to the first display parameter via the data interface when the control unit detects the “inconsistent” state of the status pin; and
setting the status pin to the “consistent” state when the update of the second display parameter is completed.

2. The method of claim 1, further comprising setting the status pin to the “consistent” state or the “inconsistent” state by changing the voltage level of the status pin.

3. The method of claim 1 wherein the video signal source sets the status pin to the “consistent” state when the update of the second display parameter is completed.

4. The method of claim 1 wherein when the update of the second display parameter is completed, the video signal source notifies the monitor control unit of the update completion of the second display parameter via the data interface, and the monitor control unit sets the status pin to the “consistent” state.

5. The method of claim 1, further comprising the control unit updating the second display parameter according to the first display parameter via the data interface when the control unit detects the “inconsistent” state of the status pin.

6. The method of claim 1 wherein the monitor further comprises a non-volatile memory for storing the first display parameter, the method further comprising the control unit updating the second display parameter according to the first display parameter when the video signal source turns on.

7. The method of claim 1 wherein the video signal source further comprises a non-volatile memory for storing the second display parameter, the method further comprising the video signal source updating the first display parameter according to the second display parameter when the video signal source turns on.

8. The method of claim 1 wherein the video signal source further comprises a source user interface, the data interface being an active control interface, the method further comprising the video signal source updating the first display parameter according to the second display parameter via the active control interface when the user adjusts the second display parameter through the source user interface while the status pin remains at the “consistent” state.

9. The method of claim 8 wherein the active control interface is a DDC/CI interface, and the video signal source updates the first display parameter according to the second display parameter via the DDC/CI interface.

10. A display system, comprising:
a monitor storing a first display parameter, the monitor being utilized for displaying a video signal according to the first display parameter, the monitor comprising:
a monitor user interface for adjusting the first display parameter; and
a monitor control unit for setting a status pin out of a “consistent” state when a user adjusts the first display parameter through the monitor user interface, the status pin capable of being selective set to or out of the “consistent” state; and
a video signal source storing a second display parameter, between the monitor and the video signal source coupling a video interface, the status pin, and a data interface, the video signal source being utilized for transmitting the video signal to the monitor via the video interface, the video signal source comprising a control unit for updating the second display parameter according to the first display parameter via the data interface when detecting the status pin being set out of the “consistent” state.

11. The display system of claim 10 wherein the status pin is for being set to or out of the “consistent” state by changing the voltage level of the status pin.

12. The display system of claim 10 wherein the control unit is for setting the status pin to the “consistent” state when the update of the second display parameter is completed.

13. The display system of claim 10 wherein the control unit is for setting the status pin to the “consistent” state when the update of the second display parameter is completed and the video signal source notifies the display control unit of the update completion of the second display parameter via the data interface.

14. The display system of claim 10 wherein the control unit is further for updating the second display parameter according to the first display parameter via the data interface when the control unit detects the status pin being set out of the “consistent” state.

15. The display system of claim 10 wherein the monitor further comprises a non-volatile memory for storing the first display parameter.

16. The display system of claim 10 wherein the video signal source further comprises a non-volatile memory for storing the second display parameter.

17. The display system of claim 10 wherein the control unit is further for updating the second display parameter according to the first display parameter when the video signal source turns on.

18. The display system of claim 10 wherein the control unit is further for updating the first display parameter according to the second display parameter when the video signal source turns on.

19. The display system of claim 10 wherein the video signal source further comprises a source user interface, the data interface being an active control interface, the control unit further for updating the first display parameter according to the second display parameter via the active control interface when the user adjusts the second display parameter through the source user interface while the status pin remains at the “consistent” state.

20. The display system of claim 19 wherein the active control interface is a DDC/CI interface, and the control unit is for updating the first display parameter according to the second display parameter via the DDC/CI interface.

21. The display system of claim 10 wherein the video interface, the data interface, and the status pin are disposed in a D-sub, a DVI, or a HDMI connector, the status pin being a pin not used by the video interface and the data interface in the D-sub, the DVI, or the HDMI connector.
